(19) United States
(12) Patent Application Publication
(10) Pub. No.: US 2020/0115922 A1
(43) Pub. Date: Apr. 16, 2020

(54) Lock Assembly

(71) Applicants: Oscar Osciel Longoria, Fort Atkinson, WI (US); Matthew Thomas Taylor, Milton, WI (US)

(72) Inventors: Oscar Osciel Longoria, Fort Atkinson, WI (US); Matthew Thomas Taylor, Milton, WI (US)

(73) Assignee: HOPPE Holding AG, Müstair (CH)

(21) Appl. No.: 16/598,668

(22) Filed: Oct. 10, 2019

Related U.S. Application Data
(60) Provisional application No. 62/743,989, filed on Oct. 10, 2018.

(51) Int. Cl. E05B 15/10; E05B 15/02; E05B 63/12

(52) U.S. Cl. CPC E05B 15/102; E05B 15/0205; E05Y 2900/132; E05B 2015/107; E05B 2015/023; E05B 63/126

(57) ABSTRACT

A lock assembly including a lock mechanism, a guide, a strike plate and an alignment track. The lock mechanism includes a lock bolt transitionable between an unlocked orientation and a locked orientation. The guide is carried by the lock bolt and travels along a path that is both parallel and perpendicular to the strike plate as the lock bolt transitions between the unlocked orientation and locked orientation. The strike plate includes a strike plate opening through which the lock bolt passes when transitioning from the unlocked orientation to the locked orientation. The alignment track engages the guide for laterally aligning the lock bolt within the strike plate opening in a direction generally orthogonal to a plane in which the lock bolt travels when transitioning from the unlocked orientation to the locked orientation. Methods of operation and door assemblies including the lock assembly are provided.

### CROSS-REFERENCE TO RELATED PATENT APPLICATIONS

This patent application claims the benefit of U.S. Provisional Patent Application No. 62/743,989, filed Oct. 10, 2018, the entire teachings and disclosure of which are incorporated herein by reference thereto.

### FIELD OF THE INVENTION

This invention generally relates to door locks and particularly lock points for door locks.

### BACKGROUND OF THE INVENTION

A door often includes one or more lock points for securing the door panel or panels in a closed state. It can be problematic if a door panel does not properly align with the door frame or inactive door panel to which it is secured to keep the door in the closed state.

For example, if the door to which the lock is mounted is in a slightly open or slightly too closed position, the lock bolt carried by the door may not properly cooperate with and insert into an opening in a strike plate of the door frame or inactive door panel such that the lock bolt is not received therein to prevent the door from moving relative to the door frame or inactive panel.

The likelihood of this problem occurring increases when multiple lock points are provided by a single door because each lock bolt of the door for each of the lock points is typically separately mounted to the door such that the individual lock points may not be perfectly oriented relative to one another as well as the corresponding strike plates of the door frame or inactive panel.

Another problem that can affect locking of a door to a door frame or inactive panel is the spacing between the lock edge of the door panel and the lock side of the door frame or the lock edge of the inactive panel. If the spacing is too great, the appropriate portions of the lock bolt may not be received in the appropriate portion of the opening in the strike plate, if at all.

A further problem with existing lock points and particularly rotary or cam actuated lock bolts of lock points and particularly lock points in multipoint locks is that one or both of the strike plate and the lock bolt are typically visible and not able to be recessed into the lock edge of the door or the door frame or lock edge of the inactive panel.

The present invention provides improvements in the art related to lock assemblies and particularly lock assemblies for multi-point lock systems.

### BRIEF SUMMARY OF THE INVENTION

A lock assembly including a lock mechanism, a guide, a strike plate and an alignment track. The lock mechanism includes a lock bolt laterally transitionable outward beyond an edge of a door panel between an unlocked orientation and a locked orientation. The guide is carried by the lock bolt and travels along a travel path that has both parallel and perpendicular components relative to the edge of the door panel as the lock bolt transitions between the unlocked orientation and locked orientation. The strike plate includes a strike plate opening through which the lock bolt passes when transitioning from the unlocked orientation to the locked orientation. The alignment track engages the guide for laterally aligning the lock bolt within the strike plate opening in a direction generally orthogonal to a plane in which the lock bolt travels when transitioning from the unlocked orientation to the locked orientation.

In one embodiment, the lock bolt is fully concealed within the lock edge of the door panel in the unlocked orientation.

In one embodiment, the strike plate is fully concealed within the lock side of the door frame or the lock edge of the in active panel relative to which the door carrying the lock assembly is maintained in a closed state.

In one embodiment, the alignment track is generally U-shaped such that the alignment track can align the lock bolt relative to the strike plate.

In one embodiment, the U-shape is wider proximate a mouth of the U-shape through which the guide enters the U-shape when the lock bolt transitions from the unlocked orientation to the locked orientation than at a bottom of the U-shape where the guide sits when the lock bolt is in the locked orientation. The wider mouth allows for increased misalignment between the door and the object to which it is being fixed in a closed state during the locking process.

In one embodiment, the lock bolt rotates about a lock axis between the unlocked orientation and the locked orientation.

In another embodiment, the lock bolt is cam actuated between the unlocked orientation and locked orientation. In a particular implementation, the lock bolt is cam driven such that it first moves perpendicular to the lock edge of the door panel and then parallel to the door panel when transitioning from the unlocked orientation to the locked orientation.

In one embodiment, the guide is a roller that rotates about a guide axis that is generally parallel to a longitudinal axis defined by the lock bolt. This form of a guide reduces friction between the lock mechanism and the strike plate during the locking process.

In one embodiment, such as when the lock bolt is a pivoting lock bolt, the guide axis is perpendicular to the lock axis.

In one embodiment, the guide is axially movable relative to the lock bolt generally parallel to the guide axis.

In one embodiment, the guide is axially spring biased away from the lock bolt. In another embodiment, the guide is axially spring biased away from the lock axis. This allows for compensating between the spacing between the door and the door frame/inactive door panel relative to which the door is to be maintained in a closed state.

In one embodiment, the guide includes a groove in the outer periphery thereof that receives at least a portion of the alignment track when the lock bolt transitions from the unlocked orientation to the locked orientation. The groove allows for further alignment functions.

In one embodiment, the lock mechanism is mountable to a door and the strike plate is mountable to an object (e.g. a door frame or an inactive door panel) to which the door is to be selectively maintained in closed state relative thereto when the lock bolt is in the locked orientation and extended through the strike plate opening.

In one embodiment, when the door is in the closed state and the lock bolt is in the locked orientation, the alignment track is axially spaced, at least in part, from a portion of the strike plate defining the strike plate opening along a longitudinal axis defined by the lock bolt.

In one embodiment, the portion of the strike plate defining the strike plate opening is a strike plate cover and the alignment track is provided by a strike plate alignment housing, the strike plate alignment housing being positioned farther from the lock axis the strike plate cover.

In one embodiment, the strike plate opening has an enlarged portion and a narrowed portion. The enlarged portion is offset from the narrowed portion. The lock bolt rests in the narrowed portion when the lock bolt is in the locked orientation. The guide passes through the enlarged portion before the lock bolt enters the narrowed portion when the lock bolt transitions from the unlocked orientation to the locked orientation.

In one embodiment, a linearly actuatable gear rack including a first set of teeth is provided. The lock bolt is part of a pivoting lock that includes a pinion gear including a second set of teeth that engages the first set of teeth. Linear actuation of the gear rack causes the pivoting lock to rotate about the lock axis to drive the lock bolt between the unlocked and locked orientations.

In one embodiment, the alignment track is arched.

In one embodiment, the arch of the alignment track substantially matches the arcuate path traveled by the guide when the lock bolt transitions from the unlocked state to the locked state while passing through the strike plate opening.

In one embodiment, the guide is axially movable relative to the lock bolt generally parallel to a longitudinal axis that is generally perpendicular to the lock axis. The guide includes a groove in the outer periphery thereof that receives at least a portion of the alignment track when the lock bolt transitions from the unlocked orientation to the locked orientation. The groove includes a tapered region that decreases in diameter when moving from a distal end of the guide towards a bottom of the groove while also traveling towards the lock axis. The tapered region axially orienting the guide relative to the alignment track along the longitudinal axis as the lock bolt is transitioned from the unlocked orientation to the locked orientation.

In one embodiment, the alignment track defines the strike plate opening.

In one embodiment, the lock bolt is cam actuated by a drive member.

In one embodiment, the drive member includes a first tapered cam surface and a first cam shelf. The lock bolt includes a second tapered cam surface and a second cam shelf. The second tapered cam surface slides along the first tapered cam surface to drive the lock bolt into the strike plate opening. The first cam shelf engaging the second cam shelf to drive the lock bolt parallel to the strike plate. Force is axially transferred from the first cam shelf to the second cam shelf.

In one embodiment, the drive member includes a first tapered cam surface and a first cam shelf. The lock bolt includes a second tapered cam surface and a second cam shelf. The second tapered cam surface slides along the first tapered cam surface to drive the lock bolt perpendicular to a door edge of a door, when in a mounted state. The first cam shelf engages and axially applies a force to the second cam shelf to drive the lock bolt parallel to the door edge of the door, when in the mounted state.

Typically, the drive member will have, at a minimum, a motion component parallel to the lock edge of the door when in a mounted state.

In another embodiment, door arrangement is provided. The door arrangement includes a door having a lock case. An object to which the door can be fixed in a closed state relative thereto is also provided. A lock assembly as outlined above is provided. The lock mechanism is mounted to the door and operably connected to the lock case for actuation of the lock bolt between the unlocked orientation and the locked orientation by operation of an actuator of the lock case. The strike plate is mounted to the object (e.g. door frame or inactive door panel). The lock mechanism and strike plate engage when the lock bolt is in the locked orientation to fix the door in the closed state relative to the object.

In one embodiment, the lock bolt extends laterally outward beyond an edge of the door when in the locked orientation.

In one embodiment, the lock bolt is fully concealed within the door when in the unlocked orientation. In one embodiment, the strike plate is fully concealed within the object (e.g. door frame or inactive door panel).

In another embodiment, a method of operating a pivoting lock assembly as outlined above is provided. The method includes pivoting the lock bolt about the lock axis to transition the lock bolt from the unlocked orientation and the locked orientation. The method includes passing the guide through the strike plate opening as the lock bolt transitions from the unlocked orientation to the locked orientation. The method includes laterally aligning the lock bolt within the strike plate opening in a direction generally orthogonal to a plane in which the lock bolt travels by engaging the guide with the alignment track while transitioning the lock bolt from the unlocked orientation to the locked orientation.

In another embodiment, a method of operating a pivoting lock assembly as outlined above is provided. The method includes cam actuating the lock bolt to transition the lock bolt from the unlocked orientation and the locked orientation. The method includes passing the guide through the strike plate opening as the lock bolt transitions from the unlocked orientation to the locked orientation. The method includes laterally aligning the lock bolt within the strike plate opening in a direction generally orthogonal to a plane in which the lock bolt travels by engaging the guide with the alignment track while transitioning the lock bolt from the unlocked orientation to the locked orientation.

In one embodiment, cam actuating includes converting linear motion of a drive member into a motion profile for the lock bolt that has both a perpendicular component and a parallel component relative to the strike plate.

In one embodiment, cam actuation includes sliding engagement between the drive member and the lock bolt to provide motion to drive the lock bolt into an enlarged portion of the strike plate opening and axial abutment between shelf portions of the drive member and the lock bolt to drive the lock bolt into a narrowed portion of the strike plate opening. The narrowed portion being offset from the enlarged portion in a direction generally parallel to the door edge or the corresponding edge or side of the door frame/inactive door panel.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a perspective illustration of a pivoting lock assembly according to an embodiment of the present invention;

FIG. 2 is a partially exploded illustration of the pivoting lock assembly of FIG. 1;

FIG. 3 is a partial illustration of a pair of double doors including a pivoting lock assembly of FIG. 1 in an installed state between the two doors in an unlocked orientation with the doors shown transparent to see the pivoting lock assembly;

FIG. 4 is a perspective illustration of a portion of the lock mechanism of the pivoting lock assembly of FIG. 1 with the lock bolt in an unlocked orientation;

FIG. 5 is a perspective illustration of a portion of the lock mechanism of the pivoting lock assembly of FIG. 1 with the lock bolt in a locked orientation;

FIG. 6 is a perspective illustration opposite that of FIG. 1 of the pivoting lock assembly;

FIG. 7 illustrates various components of the pivoting lock assembly of FIG. 1 for better illustration of various identified dimensions;

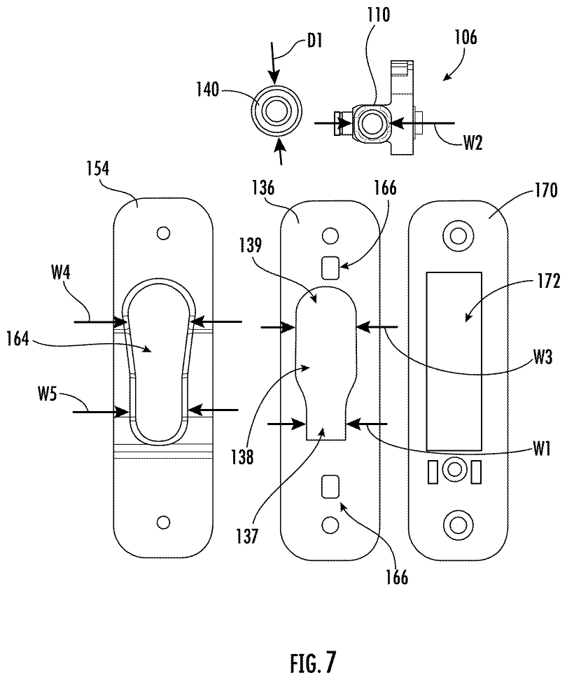

FIG. 8 is a perspective illustration of a second embodiment of a lock mechanism for use in a pivoting lock assembly;

FIG. 9 is a perspective illustration of a third embodiment of a lock mechanism in the form of a cam actuated lock assembly in an unlocked orientation;

FIG. 10 is a perspective illustration of the lock mechanism of FIG. 9 in a locked orientation;

FIG. 11 is a partial perspective illustration of the lock mechanism of FIG. 9 in an unlocked orientation;

FIG. 12 is a partial perspective illustration of the lock mechanism of FIG. 9 in a locked orientation;

FIG. 13 is a partial profile illustration of the lock mechanism of FIG. 9 in an unlocked orientation; and

FIG. 14 is a partial profile illustration of the lock mechanism of FIG. 9 in a locked orientation.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

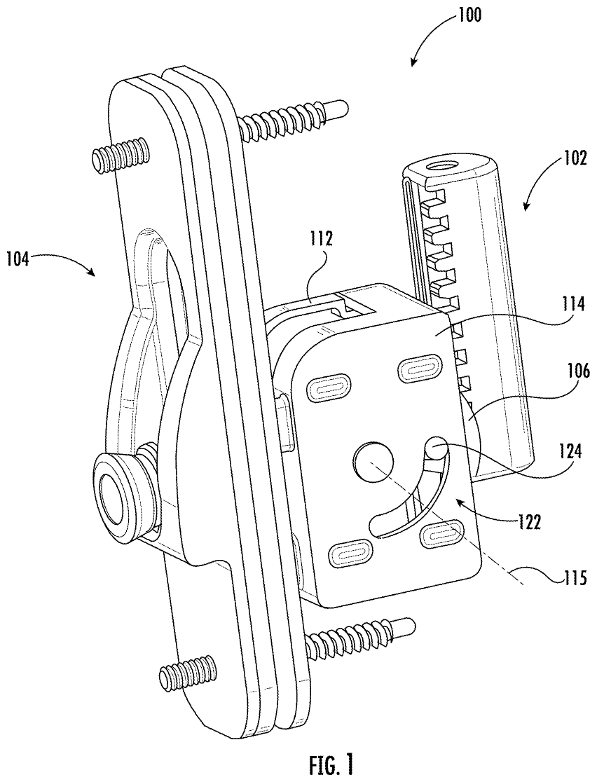

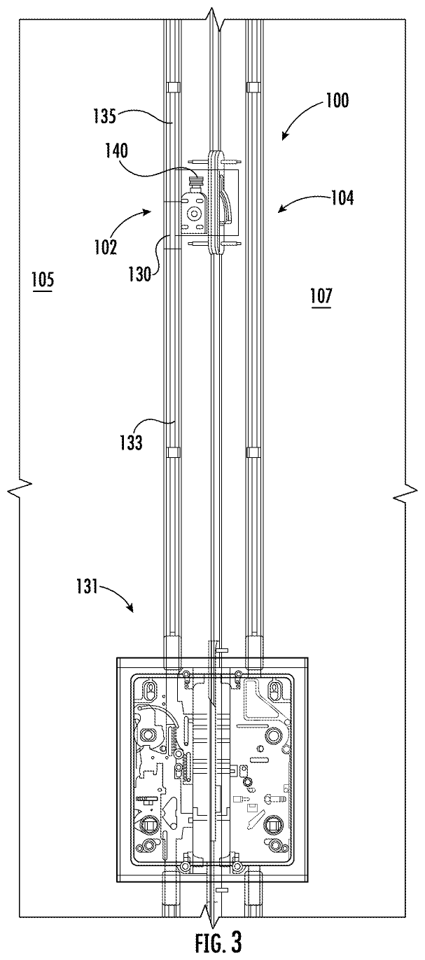

FIG. 1 illustrates a lock assembly 100 for securing a door in a closed or locked state relative to a door frame or inactive door panel. The lock assembly 100 includes a lock mechanism 102 that is, in use, carried by the door that operably cooperates with a strike plate in the form of strike plate assembly 104 that is, in use, mounted to a door frame or inactive door panel. The door and door frame/inactive door panel are not illustrated in the figures. FIG. 3 illustrates the pivot lock assembly 100 mounted in a door assembly illustrated in the form of a pair of doors 105, 107. The lock mechanism 102 is mounted in door 105 while the strike plate assembly is mounted in door 107. As used herein, a lock assembly need only be able to secure a door in a closed position relative to another object such as the door frame or inactive door panel. It could be in the form of a non-locking lock or a locking lock.

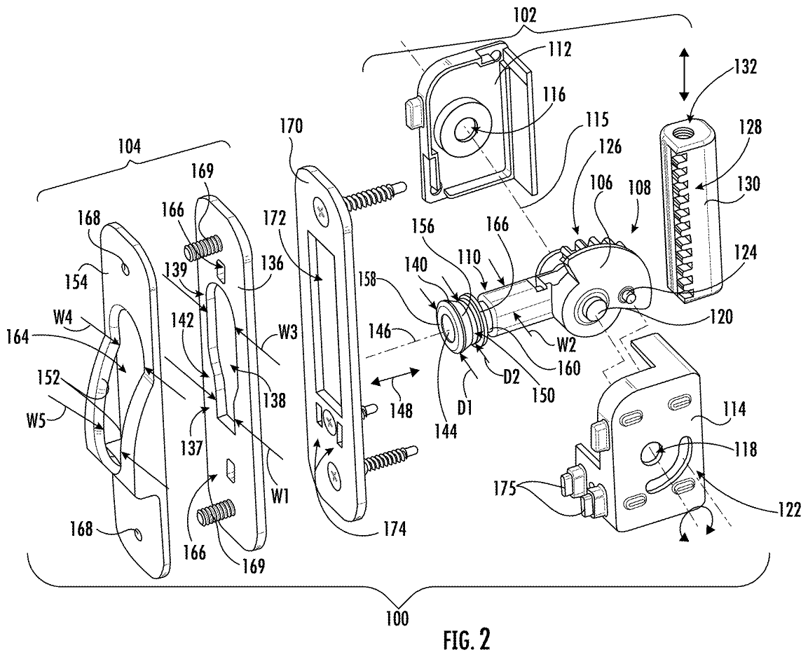

FIG. 2 illustrates the lock assembly 100 in partial exploded form.

The lock mechanism 102, of this embodiment, is a pivoting lock mechanism and includes a pivoting lock 106 that includes a pinion gear portion 108 and a lock bolt 110 extending radially outward from the pinion gear portion 108.

The pivoting lock 106 is rotatably mounted within a lock housing formed by first and second lock housing portions 112, 114 for rotation about lock axis 115. The housing portions 112, 114 include openings 116, 118 that receive corresponding hubs 120 on opposed sides of the pinion gear portion 108 (only one shown) for rotatably mounting the pivoting lock 106 between the housing portions 112, 114. In the illustrated embodiment, the hubs 120 are unitarily formed as a single piece with the pinion gear portion 108. In alternative embodiments, a mounting shaft could extend through an aperture formed in the pinion gear portion 106 for rotatably mounting the pivoting lock 106 within the housing.

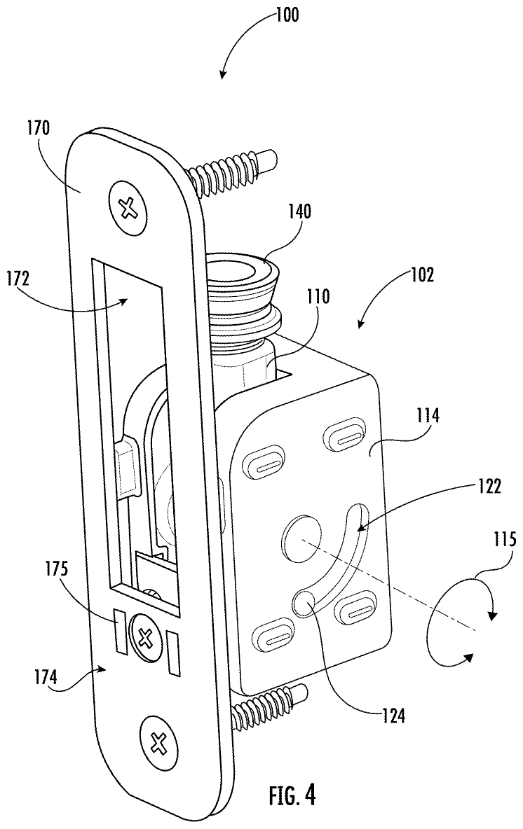

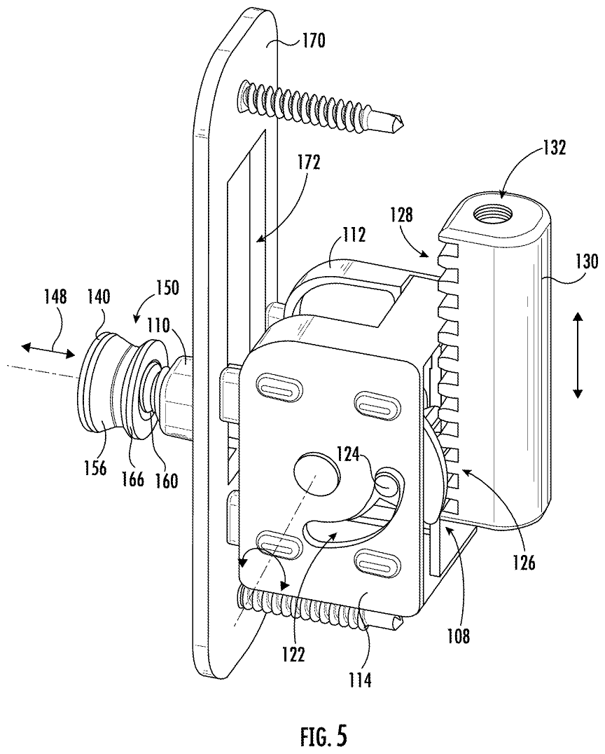

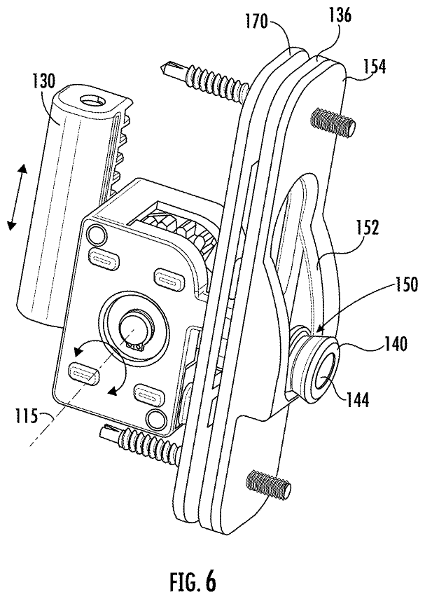

The pivoting lock 106 is designed to rotate about lock axis 115 a predetermined angular degree between a locked orientation (see FIGS. 1, 5 and 6) and an unlocked orientation (see FIGS. 3 and 4). In the illustrated embodiment, the pivoting lock 106 is designed to rotate approximately 90 degrees between the locked and unlocked orientations. Housing portion 114 includes an arc shaped slot 122 that receives rotation limiting projection 124 of pivoting lock 106 for controlling the amount of angular rotation about lock axis 115.

The pinion gear portion 108 includes a plurality of teeth 126 that engage teeth 128 of gear rack 130. In this embodiment, the teeth 126 extend outward beyond the housing formed by housing portions 112, 114 to permit engagement with gear rack 130.

The gear rack 130 is operably coupled to and driven by an actuator of a lock case 131 of a door 105 (see e.g. FIG. 3—no actuator is shown). The actuator could be, for example, a door handle, a thumb piece, a lock assembly for use with a key, a deadbolt, etc. Typically, the actuator will be manually drivable by a user. The gear rack 130 includes threaded openings 132 (only one shown) for operatively connecting the gear rack 130 to the lock case 131 or to other lock mechanisms such as in a multi-point lock system such as by way of connecting rods 133 and 135 in FIG. 3. It is noted that connecting rod 133 connects the gear rack 130 to the lock case 131 and connecting rod 135 would connect the gear rack 130 to another lock mechanism for a multi-point lock system such as, for non-limiting example, a shootbolt or another lock mechanism 102. For example, addition lock mechanisms 102 could be mounted in the lock edge of the door or in the head or sill edges of the active door panel for cooperation with corresponding strike plates mounted in corresponding sides of the door frame.

The lock bolt 110 is configured to selectively mate with a strike plate and particularly strike plate assembly 104 and even more particularly the strike plate cover 136 of strike plate assembly 104 in the illustrated embodiment. The mating interaction between the strike plate cover 136 and the lock bolt 110, at least in part, occurs when the pivoting lock 106 is in the locked orientation to secure the door in a closed or locked state. More particularly, the lock bolt 110 cooperates with a narrowed portion 137 of the lock opening 138 of the strike plate cover 136. The narrowed portion 137 has a width W1 that closely matches a width W2 of the lock bolt 110 to provide a secure closure of the door and to prevent and/or limit undesirable rattling of the door when in a locked state.

The lock opening 138 of the strike plate cover 136 includes an enlarged portion 139 through which a guide roller 140 extends when the lock bolt 110 transitions between the locked and unlocked orientations. The enlarged portion 139 is vertically above the narrowed portion 137, in the illustrated orientation. The device could be flipped upside-down in other implementations. However, in other embodiments, the different portions 137, 139 could be laterally offset from one another, e.g. if the strike plate were mounted within a door frame sill or door frame head. The enlarged portion 139 transitions into the narrowed portion 137 via a neck down region 142. The enlarged region 139 has a width W3 that is greater than width W1. The neck down region 142 is preferably a tapered region that can help, in some embodiments, guide the lock bolt 110 from the enlarged region 139 to the narrowed portion 137 when the pivoting lock transitions from the unlocked orientation to the locked orientation. Preferably, width W3 is sufficiently larger than the maximum diameter of guide roller 140 so that the pivoting lock 106 can pass through lock opening 138 to transition from the unlocked orientation to the locked orientation even when the lock bolt 110 is not perfectly aligned with the narrowed portion 137, e.g. when the door is not completely closed.

The guide roller 140 is mounted on a pin 144 fixedly attached to the lock bolt 110. The guide roller 140 is rotatable relative to the lock bolt 110 about axis 146 defined by the pin and parallel to a longitudinal axis of the lock bolt 110. In the illustrated embodiment, the guide roller 140 can also slide axially along pin 144 parallel to axis 146 as represented by arrow 148. This would be perpendicular to the lock edge of the door when the lock bolt 110 is in a locked orientation.

The guide roller 140 includes a groove 150 configured to mate with an alignment track 152 provided by the strike plate assembly 104 and particularly a strike plate alignment housing 154 of the strike plate assembly 104. The groove 150 has a minimum diameter D2 that is smaller than diameter D1 at the bottom of the groove 150. A tapered region 156 reduces in diameter when moving away from outboard distal end 158 of guide roller 140 toward the bottom of the groove 150.

Interaction of the guide roller 140 and particularly groove 150 thereof with alignment track 152 as the lock bolt 110 transitions from the unlocked orientation to the locked orientation aligns the lock bolt 110 with the narrowed portion 137. The guide roller 140 and alignment track 152 provide cam/follower relationship for properly aligning the lock bolt 110.

By using a guide roller that will rotate relative to the strike plate assembly during the locking transition, friction is reduced between the lock mechanism 102 and the strike plate assembly 104 making the locking process easier. The groove 150 prevents the guide roller 140 from being pulled/pushed out of engagement with the alignment track 152 due to variation in spacing between the door panel and door frame/inactive door panel.

The ability for the guide roller 140 to move axially along axis 146 allows for slight variation in the spacing between the edge of the door from which the lock arm extends in the locked orientation and the adjacent portion of the door frame. This reduces the precision required when installing the door relative to the door frame as well as the strike plate and lock assembly relative to the door frame and door, respectively. Preferably, the guide roller 140 is spring biased radially outward along pin 144 along axis 146. As such, if the door is too close to the frame, the guide roller 140 can be biased towards axis 115 by strike plate assembly 104 such that it can pass through alignment slot 164 defined by alignment track 152.

The alignment track 152 may be generally viewed as U-shaped with the shape having a width W4 proximate the top of the U-Shape that is greater than a width W5 proximate a bottom of the U-shape. Width W5 is substantially equal to the smaller diameter D2 of the bottom of groove 150 such that when the guide roller 140 is fully seated within the alignment track 152, the guide roller 140 cannot move laterally, e.g. parallel to width W5 and perpendicular to axis 146 within the slot 164 formed by alignment track 152.

In addition to being generally U-shaped, the alignment track 152 is also generally curved about axis 115 in a manner that generally corresponds to the arc traveled by the guide roller 140 as the lock bolt 110 transitions between the locked and unlocked orientations.

The arc traveled by the guide roller 140 between the locked and unlocked orientations includes both a longitudinal component of motion (e.g. perpendicular to the door edge when mounted) and a vertical component of motion (e.g. parallel to the door edge when mounted). This allows the guide roller 140 to be actuated out from being concealed within the lock edge of the door, across the gap formed between the locked of the door and the door frame/inactive door panel, into the strike plate and then into engagement with the alignment track and ultimately into the appropriate position relative to the strike plate. Thus, the motion of the guide roller 140 when traveling between the two orientations has both perpendicular and parallel components.

It is a feature of the embodiment that the entire lock assembly 102 can be concealed within the edge of the door (e.g. lock edge, door head edge or door sill edge—all of which may be considered a lock edge depending on the mounting location of the lock assembly) to which it is mounted when in the unlocked orientation. Similarly, the entire strike plate assembly 104 can be concealed within the lock side, head side or sill side of the door frame or the lock edge of a cooperating inactive door panel. This is a significant upgrade over prior designs where the strike plate had an opening that was exposed in a side of a door frame or inactive door panel or a lock bolt that extend out of the lock edge, sill edge or head edge of the door even in the unlocked orientation.

The strike plate cover 136 and strike plate alignment housing 154 have cooperating alignment features to properly align lock opening 138 with alignment slot 164. One or more projections and corresponding recesses can be used for such alignment. In this embodiment, the strike plate cover 136 includes recesses 166 and the strike plate alignment housing 154 has corresponding projections for appropriate alignment. These alignment features thus facilitate correct installation of the strike plate assembly 104. Further facilitating installation, the strike plate alignment housing 154 has through holes 168 through which mounting screws 169 pass. The mounting screws 169 also pass through the strike plate cover 136. It is desired that the diameter of holes 168 is smaller than the outer diameter of screws 169 so that a snug fit occurs. Depending on the material of the strike plate alignment housing 154, these holes could be self threading if mounting screws 169 are threaded through the holes to help secure the strike plate cover 136 to the strike plate alignment housing 154 during installation.

A lock assembly face plate 170 covers lock assembly 102 and secures lock assembly 102 in the door 105. A face plate aperture 172 allows the lock bolt 110 to extend outward beyond the edge of the door 105. To correctly align the face plate 170 relative to the lock assembly 102, lock housing portions 112, 114 and face plate 170 have alignment features. In the illustrated embodiment, face plate 170 includes recesses in the forms of apertures 174 that receive projections 175 formed on housing portion 114.

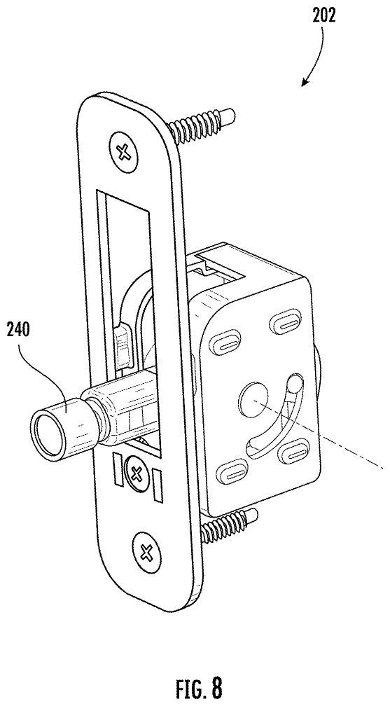

FIG. 8 illustrates an alternative embodiment of a lock assembly 200 that uses a straight guide roller 240 rather than the grooved roller 140 discussed above. The remaining components of this lock assembly 202 would have substantially identical components as the embodiment outlined above.

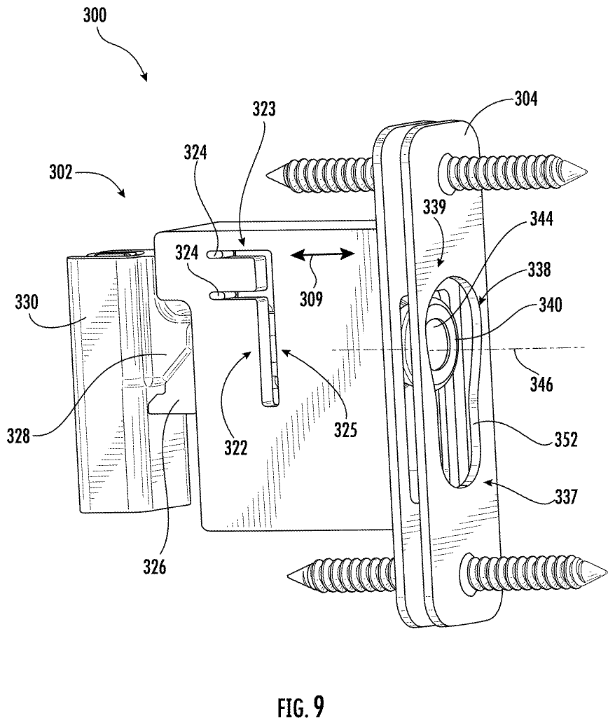

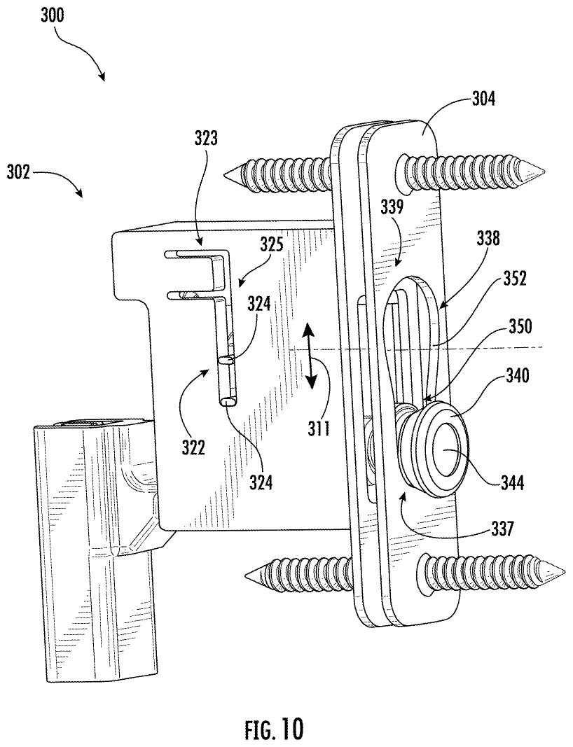

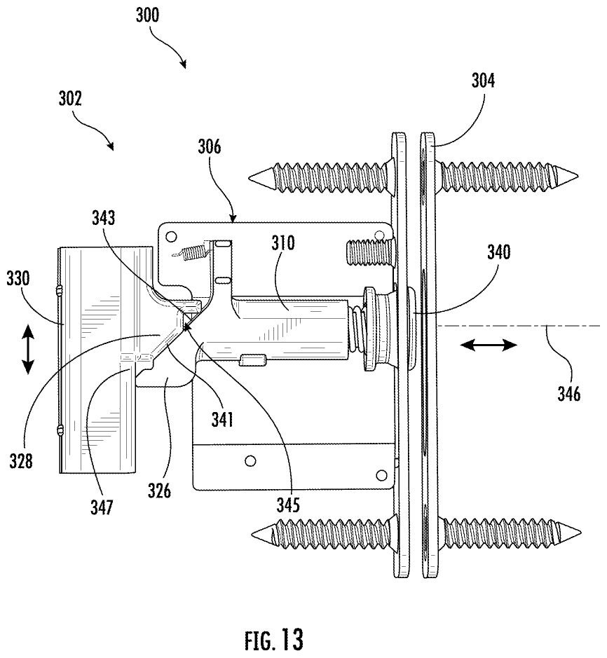

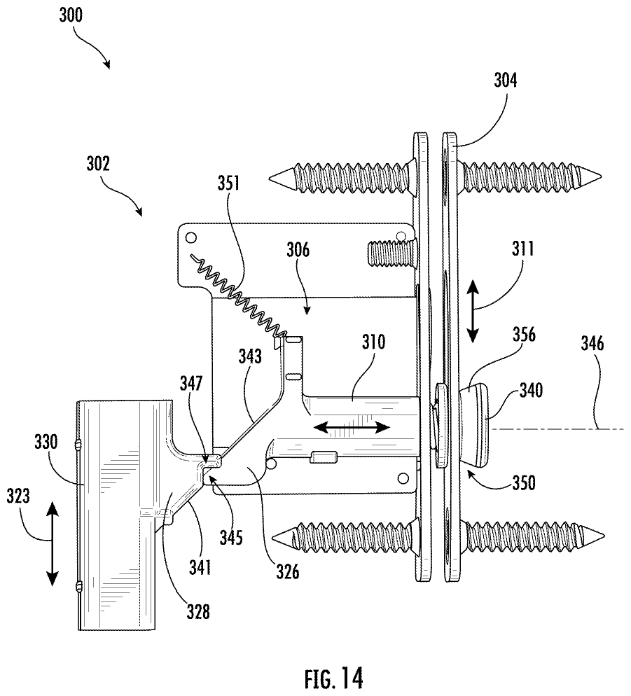

FIGS. 9-14, a further embodiment of a lock assembly 300 that utilizes a cam actuated lock mechanism 302. FIG. 9 illustrates the lock assembly 300 in an unlocked orientation. FIG. 10 illustrates the lock assembly 300 in a locked orientation. The lock mechanism 302 again cooperates with a strike plate 304.

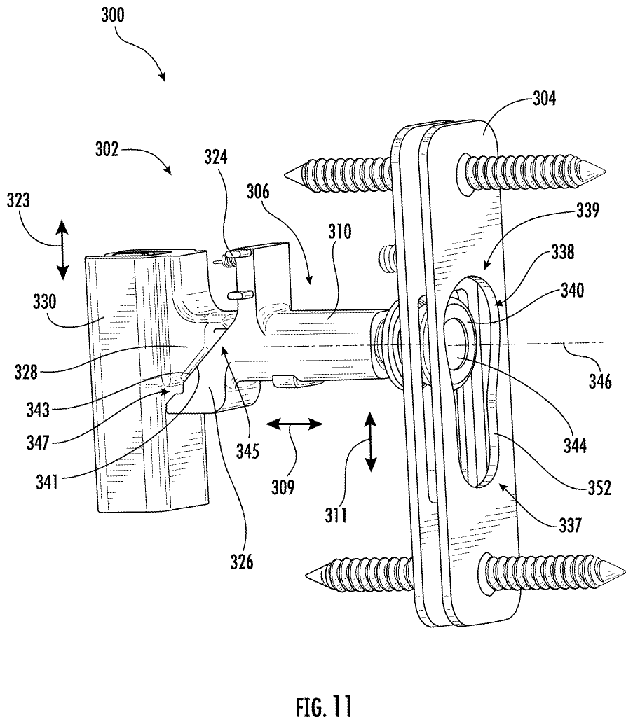

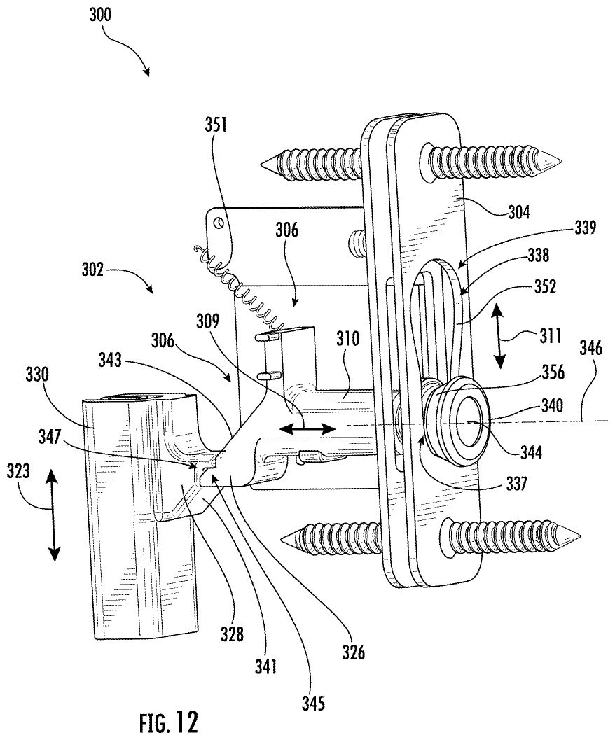

As illustrated in FIG. 11, the lock mechanism 302 includes a cam actuated lock 306 that is initially actuated linearly parallel to longitudinal axis 346 that is parallel to pin 344 and is parallel to a longitudinal axis defined by lock bolt 310. This motion is illustrated by arrow 309. Longitudinal axis 346 is perpendicular to the lock edge of the door. After being linearly actuated into lock opening 338 of strike plate 304, the lock bolt 310 is driven perpendicularly to longitudinal axis 346 (as illustrated by arrow 311) and parallel to the lock edge of the door to the final locked orientation. As such, the lock bolt 310 is driven both perpendicular and parallel to the lock edge of the door as it transitions between the unlocked orientation (FIG. 9 and FIG. 11) and the locked orientation (FIG. 10 and FIG. 12).

The lock mechanism 302 includes a housing preferably formed from first and second housing portions (only one of which is illustrated in FIGS. 9 and 10). In this embodiment, one or both of the housing portions includes a guide slot 322 that cooperates with a pair of guide projections 324 to generate the longitudinal motion parallel to axis 346 and then vertical motion perpendicular to axis 346. More particularly, the guide slot 322 includes at least one first slot portion 323 that is parallel to axis 346 that transitions into a second slot portion 325 that is perpendicular to first slot portion 323 and axis 346.

Rather than gear engagement as in the prior embodiments, the lock mechanism 302 of this embodiment includes a drive member 330 that includes a cam member 328 that selectively engages a cam follower 326 of the cam actuated lock 306.

The cam member 328 includes a first tapered cam surface 341 that sliding cooperates with a second tapered cam surface 343 of the cam actuated lock 306.

When the drive member 330 is driven perpendicular to axis 346, e.g. vertically up and down illustrated by arrow 323 in FIGS. 11 and 12 or also referred to as parallel to the door edge, first tapered cam surface 341 slides relative to second tapered cam surface 343 causing cam actuated lock 306 to be driven longitudinally out of the lock edge of the door as illustrated by arrow 309 parallel to axis 346. This drives the lock bolt 310 away from the drive member 330 and the guide roller 340 longitudinally into the enlarged portion 339 of lock opening 338 of strike plate 304. This will correspond to the longitudinal travel of guide projections 324 parallel to axis 346 within the first slot portion 323.

After sufficient vertical displacement of the drive member 330 (e.g. displacement parallel to the door edge or ultimately the door frame/inactive door panel), the lock bolt 310 will be fully inserted into lock opening 338 and the guide projections 324 will reach the second slot portion 325 of guide slot 322. Additionally, a first cam shelf 345 of the drive member 330 will axially engage a second cam shelf 347 of the cam actuated lock 306. The first and second cam shelves 345, 347 will overlap one another such that continued motion of the drive member in a downward direction as illustrated in FIG. 12 will cause linear actuation of the lock bolt 310 perpendicular to axis 346 and parallel to the lock edge of the door. This linear actuation drives the lock bolt 310 from the enlarged portion 339 into a narrowed portion 337 of the lock opening 338, e.g. to the locked orientation. Similar to prior embodiments, the groove 350 of guide roller 340 rests in and cooperates with the narrowed portion 337 of the lock opening 338 to provide limited to no motion of the door when in the closed state.

The edges of the strike plate 304 defining lock opening 338 form an alignment track 352 that is followed by guide roller 340 and properly aligns the lock bolt 310.

When a user drives drive member 330 in an opposite direction, e.g. first cam shelf 345 away from second cam shelf 347, rather than into second cam shelf 347, a biasing member in the form of coil spring 351 will return the lock bolt 310 to the unlocked orientation, e.g. first parallel to the door edge and into enlarged portion 339 and then longitudinally parallel to axis 346 back towards drive member 330.

First and second cam shelves 345, 347 are notches formed in the first and second tapered cam surfaces 341, 345.

While the illustrated embodiment provides motion illustrated by arrows 309 and 311 for the lock bolt 310 that is perpendicular to one another, such motion is not necessary.

Again, the guide roller 340 is spring loaded on pin 344 and includes tapered surface 356 like the prior embodiment to compensate in variable spacing between strike plate 304 and lock mechanism 302 (e.g. the gap between the lock edge of the door and the corresponding side of the door frame).

As such, a review of the prior embodiments illustrates that the lock bolt travels with a motion component perpendicular to the door edge as well as a motion component parallel to the door edge when transitioning between the locked and unlocked orientations. In some embodiments, the motion is an arc that provides both motion components. In other embodiments, the motion is a combination of linear movements. Further, the linear movements need not be simply parallel or perpendicular to the door edge, but could be at an angle relative thereto. Further, the motion perpendicular to the door edge could occur simultaneous with the motion that is parallel to the door edge (e.g. the arc or linear motion at a non-perpendicular non-parallel angle relative to the door edge).

Further, in the unlocked orientations, the lock bolt can be fully concealed within the door panel. For example, the lock bolt does not extend out beyond the lock mechanism cover plate when in an unlocked orientation.

As noted above, the inclusion of a guide roller reduces frictional engagement between the lock bolt and the corresponding strike plate during locking and unlocking operations.

The guide roller that is described as being carried by the lock bolt may be considered part of the lock bolt.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A lock assembly comprising:
a lock mechanism including a lock bolt between an unlocked orientation and a locked orientation, the lock bolt being fully concealed when in the locked orientation;
a guide carried by the lock bolt as the lock bolt transitions between the unlocked orientation and locked orientation;
a strike plate including a strike plate opening through which the lock bolt passes when transitioning from the unlocked orientation to the locked orientation, the lock bolt traveling both perpendicular to and parallel to the strike plate when transitioning from the unlocked orientation to the locked orientation; and
an alignment track engageable with the guide for laterally aligning the lock bolt within the strike plate opening in a direction generally orthogonal to a plane in which the lock bolt travels when transitioning from the unlocked orientation to the locked orientation.

2. The lock assembly of claim 1, wherein the alignment track is generally U-shaped.

3. The lock assembly of claim 2, wherein the U-shape is wider proximate a mouth of the U-shape through which the guide enters the U-shape when the lock bolt transitions from the unlocked orientation to the locked orientation than at a bottom of the U-shape where the guide sits when the lock bolt is in the locked orientation.

4. The lock assembly of claim 1, wherein the guide is a roller that rotates about a guide axis.

5. The lock assembly of claim 4, wherein the guide is axially movable parallel to the guide axis.

6. The lock assembly of claim 1, wherein the guide is axially spring biased along the guide axis.

7. The lock assembly of claim 4, wherein the guide includes a groove in the outer periphery thereof that receives at least a portion of the alignment track when the lock bolt transitions from the unlocked orientation to the locked orientation.

8. The lock assembly of claim 1, wherein the lock mechanism is mountable to a door and the strike plate is mountable to an object to which the door is to be selectively maintained in closed state relative thereto when the lock bolt is in the locked orientation and extended through the strike plate opening.

9. The lock assembly of claim 8, wherein when the door is in the closed state and the lock bolt is in the locked orientation, the alignment track is axially spaced, at least in part, from a portion of the strike plate defining the strike plate opening along a longitudinal axis defined by the lock bolt.

10. The lock assembly of claim 9, wherein the portion of the strike plate defining the strike plate opening is a strike plate cover and the alignment track is provided by a strike plate alignment housing, the strike plate alignment housing being positioned farther from the lock axis the strike plate cover.

11. The lock assembly of claim 1, wherein the strike plate opening has an enlarged portion and a narrowed portion, the enlarged portion is offset from the narrowed portion, the lock bolt resting in the narrowed portion when the lock bolt is in the locked orientation, the guide passing through the enlarged portion before the lock bolt enters the narrowed portion when the lock bolt transitions from the unlocked orientation to the locked orientation.

12. The lock assembly of claim 1, further comprising a linearly actuatable gear rack including a first set of teeth;
wherein:
the lock bolt is part of a pivoting lock that includes a pinion gear including a second set of teeth that engages the first set of teeth;
the linear actuation of the gear rack causes the pivoting lock to rotate about the lock axis to drive the lock bolt between the unlocked and locked orientations.

13. The lock assembly of claim 1, wherein the alignment track is arched.

14. The lock assembly of claim 13, wherein:
the guide travels along an arcuate path when the lock bolt transitions from the unlocked orientation to the locked orientation;
the arch of the alignment track substantially matches the arcuate path traveled by the guide when the lock bolt transitions from the unlocked state to the locked state while passing through the strike plate opening.

15. The lock assembly of claim 14, wherein:
the guide is axially movable relative to the lock bolt generally parallel to a longitudinal axis that is generally perpendicular to a lock axis about which the lock bolt rotates when transitioning between the unlocked orientation and the locked orientation;
the guide includes a groove in the outer periphery thereof that receives at least a portion of the alignment track when the lock bolt transitions from the unlocked orientation to the locked orientation;
the groove includes a tapered region that decreases in diameter when moving from a distal end of the guide towards a bottom of the groove while also traveling towards the lock axis; and
the tapered region axially orienting the guide relative to the alignment track along the longitudinal axis as the lock bolt is transitioned from the unlocked orientation to the locked orientation.

16. The lock assembly of claim 1, wherein the alignment track defines the strike plate opening.

17. The lock assembly of claim 1, wherein the lock bolt is cam actuated by a drive member.

18. The lock assembly of claim 17, wherein:
the drive member includes a first tapered cam surface and a first cam shelf;
the lock bolt includes a second tapered cam surface and a second cam shelf;
the second tapered cam surface slides along the first tapered cam surface to drive the lock bolt into the strike plate opening; and
the first cam shelf engaging the second cam shelf to drive the lock bolt parallel to the strike plate.

19. The lock assembly of claim 17, wherein:
the drive member includes a first tapered cam surface and a first cam shelf;
the lock bolt includes a second tapered cam surface and a second cam shelf;
the second tapered cam surface slides along the first tapered cam surface to drive the lock bolt perpendicular to a door edge of a door, when in a mounted state; and
the first cam shelf engaging and axially applying a force to the second cam shelf to drive the lock bolt parallel to the door edge of the door, when in the mounted state.

20. A door arrangement comprising:
a door having a lock case;
an object to which the door can be fixed in a closed state relative thereto;
a lock assembly of claim 1, wherein:
the lock mechanism is mounted to the door and operably connected to the lock case for actuation of the lock bolt between the unlocked orientation and the locked orientation by operation of an actuator of the lock case;
the strike plate is mounted to the object; and
the lock mechanism and strike plate engaging when the lock bolt is in the locked orientation to fix the door in the closed state relative to the object.

21. The door arrangement of claim 20, wherein the lock bolt extends laterally outward beyond an edge of the door when in the locked orientation.

22. The door arrangement of claim 20, wherein the lock bolt is fully concealed within the door when in the unlocked orientation.

23. A method of operating a lock assembly of claim 1 comprising:
pivoting the lock bolt about the lock axis to transition the lock bolt from the unlocked orientation and the locked orientation;
passing the guide through the strike plate opening as the lock bolt transitions from the unlocked orientation to the locked orientation; and
laterally aligning the lock bolt within the strike plate opening in a direction generally orthogonal to a plane in which the lock bolt travels by engaging the guide with the alignment track while pivoting the lock bolt from the unlocked orientation to the locked orientation.

24. A method of operating a lock assembly claim 1 comprising:
cam actuating the lock bolt to transition the lock bolt from the unlocked orientation and the locked orientation;
passing the guide through the strike plate opening as the lock bolt transitions from the unlocked orientation to the locked orientation; and
laterally aligning the lock bolt within the strike plate opening in a direction generally orthogonal to a plane in which the lock bolt travels by engaging the guide with the alignment track while transitioning the lock bolt from the unlocked orientation to the locked orientation.

25. The method of claim 24, wherein cam actuating includes converting linear motion of a drive member into a motion profile for the lock bolt that has both a perpendicular component and a parallel component relative to the strike plate.

26. The method of claim 25, wherein cam actuation includes sliding engagement between the drive member and the lock bolt to provide motion to drive the lock bolt into an enlarged portion of the strike plate opening and axial abutment between shelf portions of the drive member and the lock bolt to drive the lock bolt into a narrowed portion of the strike plate opening.
